(19) United States
(12) Patent Application Publication
(10) Pub. No.: US 2004/0003036 A1
(43) Pub. Date: Jan. 1, 2004

(54) Identifying the source of messages presented in a computer system

(76) Inventors: Scott G. Eagle, Menlo Park, CA (US); L. Scott Primak, San Jose, CA (US); Anthony G. Martin, Los Altos, CA (US)

Correspondence Address: OKAMOTO & BENEDICTO, LLP, P.O. BOX 641330, SAN JOSE, CA, 95164, US

(21) Appl. No.: 10/189,757

(22) Filed: Jul. 2, 2002

Related U.S. Application Data
(60) Provisional application No. 60/385,775, filed on Jun. 4, 2002.

(51) Int. Cl. G06F 17/60; G06F 15/16

(52) U.S. Cl. 709/203; 705/14; 705/59

(57) ABSTRACT

In one embodiment, a consumer is informed of a source of messages (“source”) during the downloading of an item over a network. Thereafter, messages delivered to the consumer are marked with a source indicator. An educational campaign may also be launched to further provide information about the source. For example, additional messages may be delivered to the consumer, with some of the messages containing further information about the source. The educational campaign not only helps in identifying the source, but also helps in ensuring that the consumer fully understands, and acknowledges, any agreement that the consumer entered into during the download process. In one embodiment, user interfaces that are in close proximity to each other are assigned different activation sequences to help prevent inadvertent activation of a user interface.

### CROSS-REFERENCE TO RELATED APPLICATION

The present application claims the benefit of U.S. Provisional Application No. 60/385,775, entitled “IDENTIFYING THE SOURCE OF MESSAGES PRESENTED IN A COMPUTER SYSTEM”, filed by Scott G. Eagle and L. Scott Primak on Jun. 4, 2002.

### BACKGROUND OF THE INVENTION

1. Field of the Invention

The present invention relates generally to computer systems, and more particularly to methods and apparatus for identifying the source of a message presented in a computer system.

2. Description of the Background Art

The computer industry has a lot of participants. In addition to the multitude of hardware and software vendors, there are companies engaged in providing computer-related services such as Internet service providers, e-commerce vendors, voice-over-IP telephony companies, etc. While the large number of vendors beneficially results in more choices for the consumer, it also brings with it the problem of identifying the sources of messages presented in a computer system. For example, because of the large number of computer programs installed in a typical computer, identifying the particular computer program that generated a message on the computer's screen can sometimes be difficult.

Identifying the source of a message is specially problematic on the Internet. A consumer surfing on the Internet will typically receive one or more messages in the course of navigating from one web site to another. These messages are typically, but not necessarily, product (i.e., goods or services) advertisements. Although an advertisement will most likely spell out the product being promoted, the source of the advertisement itself may not be easy to identify. The advertisement could have been embedded in a web page currently being viewed or previously viewed by the consumer. The advertisement could have been generated by a server computer, commonly referred to as an “ad server”, delivering advertisements to the just mentioned web page. The advertisement could also have been generated by a computer program resident in the consumer's computer, or by the consumer's Internet service provider.

From the foregoing, an improved technique for identifying the source of a message presented in a computer system is highly desirable.

### SUMMARY

The present invention relates to methods and apparatus for identifying the source of messages presented in a computer system. The present invention may be used in a variety of applications including in the identification of the source of a message received locally or over a computer network such as the Internet. Embodiments of the present invention help minimize consumer confusion, allow for acknowledgement of agreements, and/or assist consumers in gaining more understanding about products being offered to or accepted by them.

In one embodiment, a consumer is informed of a source of messages (hereinafter “source”) during the downloading of an item over a network. Thereafter, messages delivered to the consumer are marked with a source indicator. An educational campaign may also be launched to further provide information about the source. For example, additional messages may be delivered to the consumer, with some of the messages containing further information about the source. The educational campaign not only helps in identifying the source, but also helps in ensuring that the consumer fully understands, and acknowledges, any agreement that the consumer entered into during the download process.

In one embodiment, user interfaces that are in close proximity to each other are assigned different activation sequences to help prevent inadvertent activation of a user interface.

These and other features and advantages of the present invention will be readily apparent to persons of ordinary skill in the art upon reading the entirety of this disclosure, which includes the accompanying drawings and claims.

### DESCRIPTION OF THE DRAWINGS

FIG. 1 shows a schematic diagram of a computer network in accordance with an embodiment of the present invention.

FIGS. 2A and 2B show schematic representations of a web browser and various vehicles for displaying messages.

FIG. 3 shows a flow diagram of a method of providing an item to a consumer.

FIGS. 4A, 4B, 5A and 5B show various messages in accordance with embodiments of the present invention.

FIG. 6 shows a flow diagram of a method of identifying a source of messages in accordance with an embodiment of the present invention.

FIGS. 7A and 7B show message delivery vehicles in accordance with embodiments of the present invention.

The use of the same reference label in different drawings indicates the same or like components.

### DETAILED DESCRIPTION

In the present disclosure, numerous specific details are provided such as examples of computers and methods to provide a thorough understanding of embodiments of the invention. Persons of ordinary skill in the art will recognize, however, that the invention can be practiced without one or more of the specific details. In other instances, well-known details are not shown or described to avoid obscuring aspects of the invention. For example, the mechanics of delivering messages over the Internet and displaying messages on a computer screen, in general, are known in the art and will not be described here.

The present invention is described in the context of advertisement delivery over the Internet. It should be understood, however, that the present invention is not so limited and may be used in other applications requiring identification of sources of messages presented in a computer system.

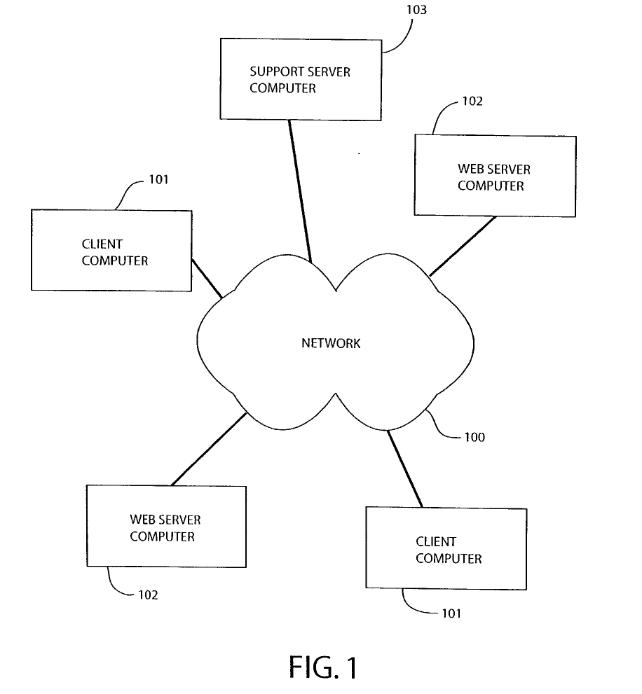

Referring now to FIG. 1, there is shown a schematic diagram of a computer network in accordance with an embodiment of the present invention. A network 100 includes one or more client computers 101, one or more web server computers 102, one or more support server computers 103, and other computers not shown. Intermediate nodes such as gateways, routers, bridges, Internet service provider networks, public-switched telephone networks, proxy servers, firewalls, etc. are not shown for clarity. In the embodiment of FIG. 1, network 100 includes the Internet; however, any type of computer network may also be used. Computers may be coupled to network 100 using any type of connection without detracting from the merits of the present invention.

A client computer 101 is typically, but not necessarily, a personal computer such as those running the Microsoft Windows™, Apple Macintosh™, Linux etc. operating systems. A user employs a suitably equipped client computer 101 to get on network 100 and access computers coupled thereto. For example, a client computer 101 may be used to access web pages from a web server computer 102. It is to be noted that the term “computer” includes any type of information processing device including personal digital assistants, digital telephones, wireless terminals, etc.

A web server computer 102 may be a web site containing information designed to attract users surfing on the Internet. A web server computer 102 may also include advertisements, downloadable computer programs, and products available for online purchase. A web server computer 102 may also be an ad server and deliver advertisements to a client computer 101.

A support server computer 103 may include the functionalities of a web server computer 102. Additionally, a support server computer 103 may include files and downloadable computer programs for supporting, updating, or maintaining components on a client computer 101. Web server computers 102 and support server computers 103 are typically, but not necessarily, server computers such as those available from Sun Microsystems, Hewlett-Packard, International Business Machines, etc. A client computer 101 communicates with a web server computer 102 or a support server computer 103 using client-server protocol. Client-server computing is well known in the art and will not be further described here.

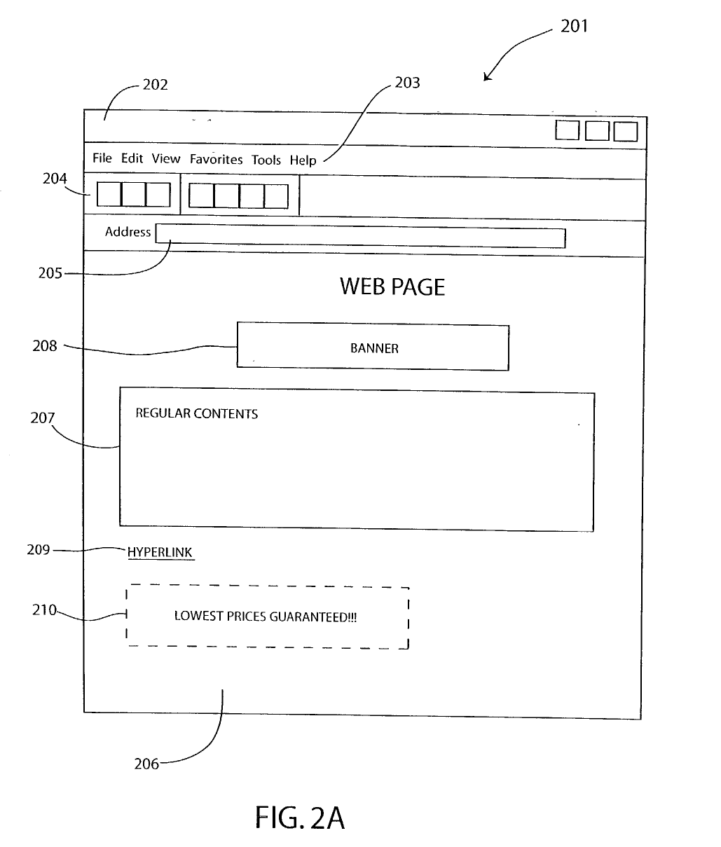

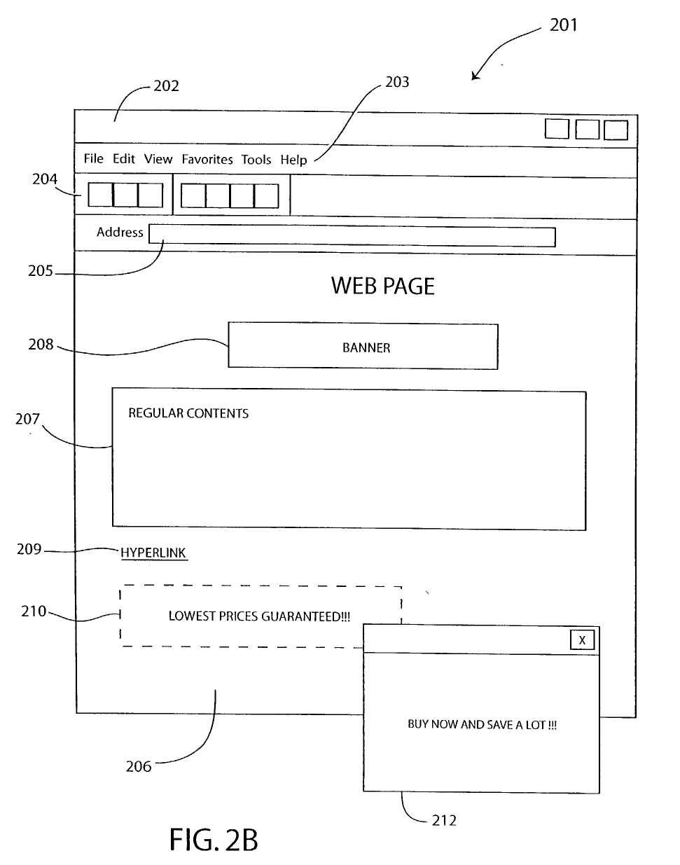

FIG. 2A shows a schematic representation of a web browser 201. Web browser 201 may be any web browser or web client running on a client computer 101. For example, the Microsoft Internet Explorer™ web browser may be used as a web browser 201. In one embodiment, web browser 201 includes a title bar 202 for displaying the title of a web page 206. A menu bar 203 includes pull down menus for various functions, while a tool bar 204 provides shortcuts to various functions. An address window 205 displays the uniform resource locator (URL) of web page 206.

Web page 206 is typically, but not necessarily, a HyperText Markup Language (HTML) document displayed on the window portion of web browser 201. Web page 206 may be hosted in a server computer such as a web server computer 102 or support server computer 103. Web page 206 may be viewed by a consumer with a client computer 101 running a web browser 201. A consumer may view web page 206 by getting it from its host server computer over network 100.

Web page 206 may include regular contents 207, which may be designed to attract consumers to web page 206. Examples of regular contents 207 include news, educational materials, on-line forums, search engines, products for sale, product information, maps, voice-over-IP services, stock market information, on-line gaming, etc. In addition to regular contents 207, web page publishers may also display various advertisements to the consumer. Thus, consumers who wish to access regular contents 207 may also have to view some advertisements. It is to be noted that as used in the present disclosure, “advertising” or “advertisement” includes any type of message provided to consumers for the purpose of getting the consumers' attention on something. Typically but not necessarily, an advertisement is with regards to a product. However, an advertisement may also be related to an election campaign, a cause (e.g., “save the planet”), an announcement, etc.

An advertisement may be displayed using various types of message delivery vehicles. As shown in FIG. 2A, examples of message delivery vehicles for displaying advertisements include a banner 208, a hyperlink 209, and a data area 210 of web page 206. Advertisements displayed in banner 208 may be from the server computer hosting web page 206 or from a dedicated ad server. Because banner 208 is displayed along with web page 206 in the example of FIG. 2A, consumers may (rightly or wrongly) associate banner 208 with the publisher of web page 206. That is, consumers may assume that any advertisement appearing in banner 208 is provided by the publisher of web page 206 or a source associated with the publisher of web page 206.

An advertisement may be displayed in a hyperlink 209, which provides a link to another web page containing more information about the advertisement. An advertisement may also be displayed in a data area 210. Data area 210 may include text or graphical data hard coded in web page 206. For example, an advertisement that includes the language “Lowest Prices Guaranteed” may be included as a text of an HTML document. An advertisement may also be displayed in a window separate from browser 201. For example, as shown in FIG. 2B, an advertisement may be displayed in a pop-up window 212. As is the case with banner 208, consumers may associate advertisements displayed in hyperlink 209, in data area 210, or pop-up window 212 with the publisher of web page 206.

In some embodiments of the present invention, messages such as advertisements may be delivered in a way that minimizes confusion as to the source of the message. In one embodiment, a consumer is informed of a source of advertisements during the downloading of an item over a computer network. A computer program that facilitates delivery of advertisements, hereinafter referred to as an “advertising delivery engine”, may also be downloaded along with the item. Thereafter, advertisements provided to the consumer may be marked with a source indicator such as a logo to identify the source of the advertisements. An educational campaign may be initiated to further provide information about the source of advertisements. For example, additional advertisements may be provided to the consumer, with some of the advertisements containing further information about the source of the advertisements. The educational campaign not only helps in familiarizing the consumer with the source of the advertisements, but also helps ensure that the consumer fully understands, and acknowledges, any agreement that the consumer entered into during the download of the item. An educational campaign may be performed for a period of time for consumers new to the source, or periodically for all consumers.

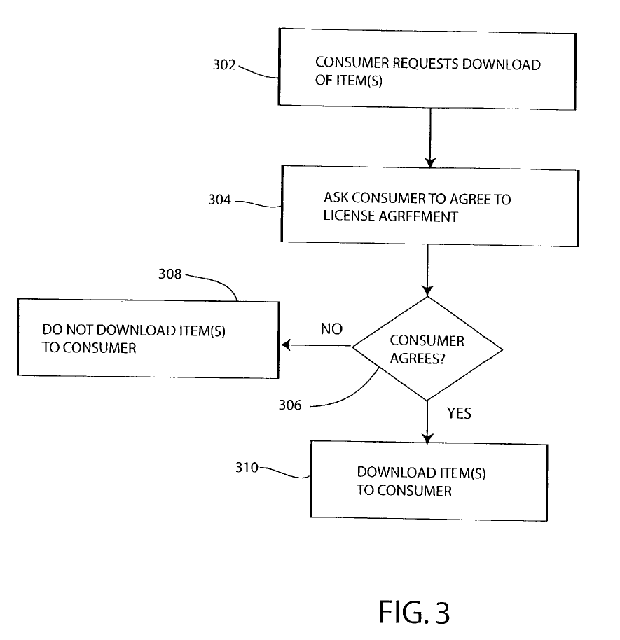

FIG. 3 shows a flow diagram of a method of providing an item to a consumer, which may be used in an embodiment of the present invention. In action 302, a consumer who may be surfing on the Internet requests to download an item from a server computer. The item may be a computer program, map, wallpaper, music, etc. For example, the consumer may request to download a utility program such as an electronic wallet of the type available from the web site of The Gator Corporation of Redwood City, Calif.

In action 304, the consumer is asked to agree to a license agreement, sometimes referred to as an “End-User License Agreement”, before being allowed to download the requested item. For example, the requested item may be provided to the consumer at a reduced cost or free of charge in return for the right to deliver advertising (and other promotional materials) to the consumer. In essence, advertising delivered to the consumer would help pay for the cost of creating and maintaining the requested item.

Advantageously, the license agreement shown to the consumer in action 304 would explain the terms of the license agreement including who will be sending advertisements to the consumer. For example, a license agreement may include the following language:

PLEASE READ THIS PRIVACY STATEMENT AND END USER LICENSE AGREEMENT (COLLECTIVELY “Terms and Conditions”) CAREFULLY AND MAKE SURE YOU UNDERSTAND THEM. They govern anything you CHOOSE TO receive from The Adco Corporation, or third parties, IN EXCHANGE FOR YOUR ALLOWING THE ADCO CORPORATION TO BRING YOU THINGS LIKE ADVERTISEMENTS, INFORMATION, AND SOFTWARE (COLLECTIVELY “ADCOWare”). YOU ARE BEING OFFERED, AND WILL RECEIVE, ADCOWare ONLY IF YOU ACCEPT THESE Terms and Conditions, THEY CONTAIN IMPORTANT INFORMATION THAT YOU SHOULD KNOW BEFORE USING ADCOWare. THESE Terms and Conditions REPLACE ANY PREVIOUS VERSIONS THAT YOU MAY HAVE AGREED TO.

YOU MAY TERMINATE THESE Terms and Conditions AT ANY TIME BY UNINSTALLING ALL ADCOWare FROM YOUR COMPUTER USING THE ADD/REMOVE PROGRAMS MENU IN YOUR MICROSOFT (R) WINDOWS (R) CONTROL PANEL, AND DESTROYING ANY OTHER COPIES OF ADCOWare YOU MAY HAVE MADE . . .

In the above mentioned license agreement language, a fictitious corporation named “The Adco Corporation” may send advertisements (and other things) to the consumer so long as the consumer retains any item the consumer originally received from The Adco Corporation. Of course, the above mentioned license agreement language is provided for purposes of illustration and not limiting.

In actions 306 and 308, the consumer is not allowed to download the requested item if the consumer does not agree to the license agreement.

In actions 306 and 310, the consumer is allowed to download the requested item if the consumer agrees to the license agreement. An advertising delivery engine may also be downloaded along with the requested item to facilitate delivery of advertisements to the consumer.

Ideally, the consumer should read and understand the entirety of a license agreement before deciding whether or not to agree to it. However, some consumers readily agree to license agreements without giving much though as to what they are agreeing to. Thus, in some embodiments of the present invention, additional actions are taken to help identify the source of advertisements delivered to the consumer and also to remind the consumer of some of the terms of the license agreement.

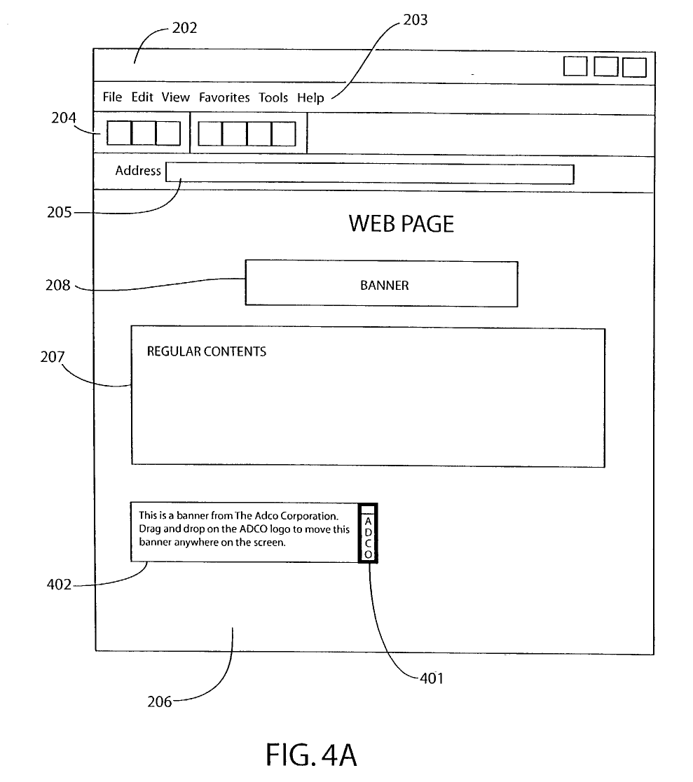

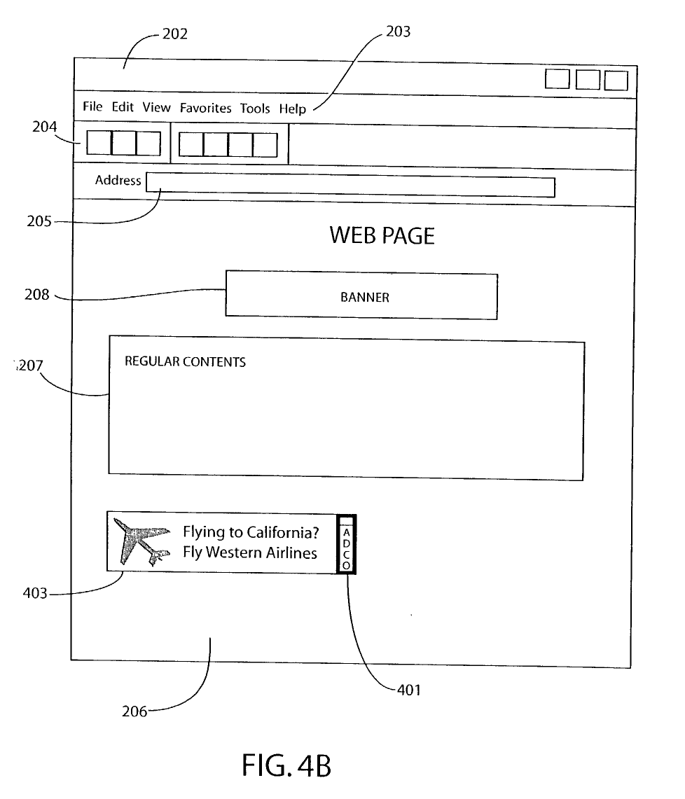

FIG. 4A shows a message 402 according to an embodiment of the present invention. Message 402 includes information explaining to the consumer how a message (e.g., advertisement) from a particular source may look like and, optionally, how the message may be relocated within a computer screen. Message 402 also includes a logo 401 identifying the source of the message. A message 402 may be delivered to the consumer as part of an educational campaign to familiarize the consumer with the look and feel of messages provided by a specific source, which in this example are advertisements from The Adco Corporation.

FIG. 4B illustrates the use of a logo 401 in a message 403. As can be appreciated, logo 401 identifies the source of message 403 and helps prevent the consumer from associating message 403 with the publisher of web page 206. Additionally, an educational campaign including a message 402 (see FIG. 4A) also helps in preventing consumer confusion as to the source of message 403.

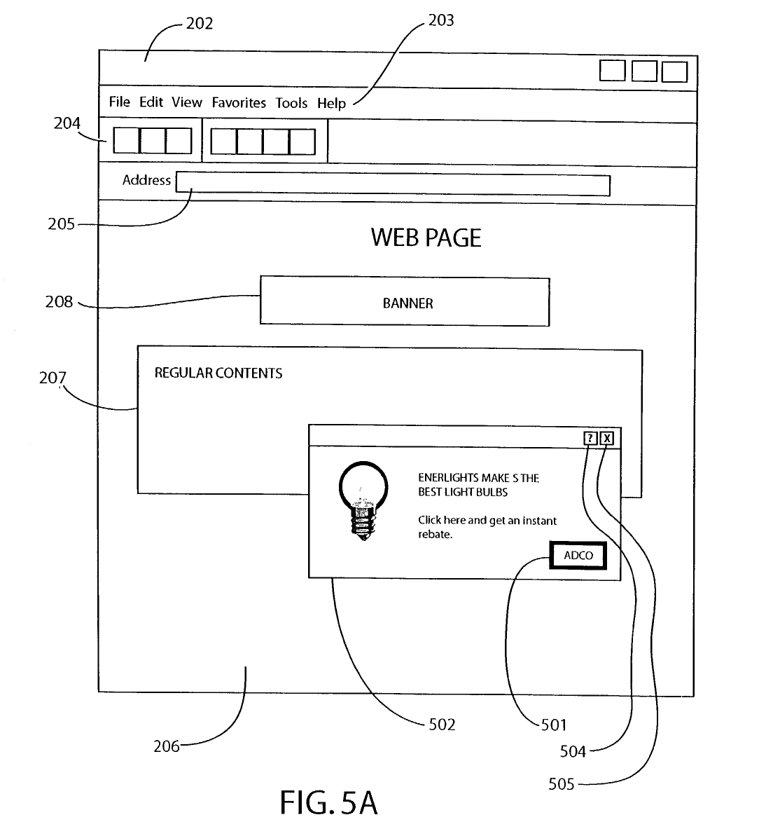

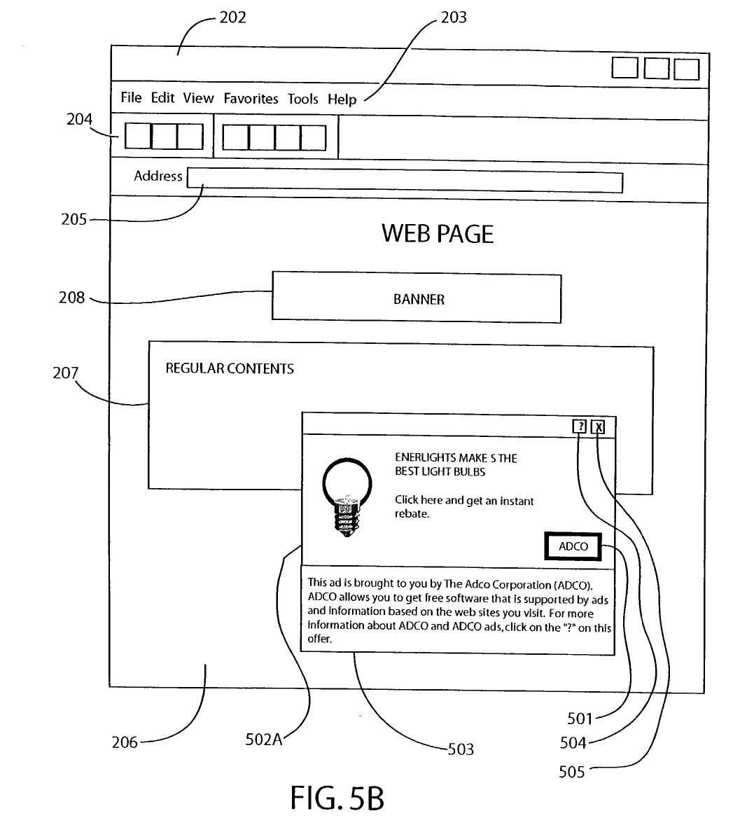

FIG. 5A illustrates another example of using a source indicator such as a logo 501 to identify the source of a message 502. In the example of FIG. 5A, message 502 is an advertisement for a light bulbs company; logo 501 identifies The Adco Corporation as the source of the advertisement. Logo 501 helps prevent a consumer from mistakenly thinking that message 502, which is an advertisement from The Adco Corporation in this example, is from the publisher of web page 206. The window containing message 502 may include an information icon 504 for providing more information about message 502. In one embodiment, clicking (e.g., with a mouse or pointing device) on information icon 504 brings-up an explanation of portions or the entirety of a license agreement the consumer accepted. Clicking on information icon 504 may also bring-up information on how to rescind the license agreement. Clicking on information icon 504 may also bring-up information about the source of message 502. A remove icon 505 allows a consumer to remove message 502 off her computer screen.

FIG. 5B shows a message 502A delivered to the consumer as part of an educational campaign. Message 502A is a specific embodiment of a message 502 shown in FIG. 5A. Message 502A includes a frame 503, which contains additional information regarding the source of message 502A. In the example of FIG. 5B, frame 503 informs the consumer that message 502A is from The Adco Corporation and that ADCO software (which may have been downloaded by the consumer) is supported by advertisements. Frame 503 also informs the consumer that the advertisements delivered by ADCO are based on web sites the consumer visits. The window containing message 502A may also include an information icon 504 that may be clicked on to bring-up information regarding a license agreement the consumer has accepted, how to rescind the license agreement, the source of message 502A, or combinations thereof. A remove icon 505 allows a consumer to remove message 502A off her computer screen. As can be appreciated, an educational campaign including a message 502A reminds the consumer of the terms of the license agreement. This puts the consumer on notice of the license agreement and, in effect, allows the consumer to acknowledge its terms.

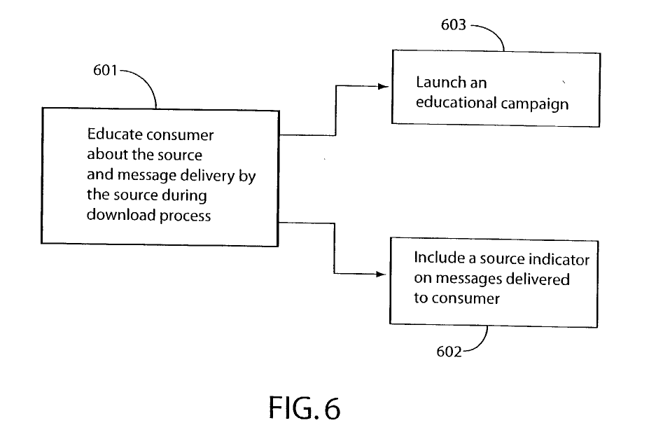

Referring now to FIG. 6, there is shown a flow diagram of a method of identifying a source of messages according to an embodiment of the present invention. In action 601, a consumer is informed of messages that will be delivered to her in exchange for allowing her to download an item. The item may be, for example, a computer program provided free of charge or at a reduced cost. In action 601, the consumer may also be provided specific information regarding the source of the subsequently delivered messages.

Action 601 may include showing the consumer a license agreement, and giving her the opportunity to cancel the download process if she does not agree with the license agreement. The consumer may also be informed of how the messages will be delivered, how the messages will look like, how to stop delivery of messages to her, and the like. Information provided to the consumer during the download process may be presented using a variety of message delivery vehicles including, without limitation, text boxes, message boxes, separate windows, etc.

In action 602, a message delivered to the consumer may include a source indicator to identify the source of the message. The source indicator may be a logo, a company name, a slogan, or a distinctive look and feel (e.g., stylized borders), for example.

In action 603, an educational campaign may be launched to teach the consumer how to identify messages from a particular source. The educational campaign may also be used to remind the consumer of certain terms of a license agreement, and to put the consumer on notice of the license agreement. Educational campaign messages may be delivered only to those consumers who just accepted the license agreement within a certain period of time. Educational campaign messages may also be delivered periodically to all consumers.

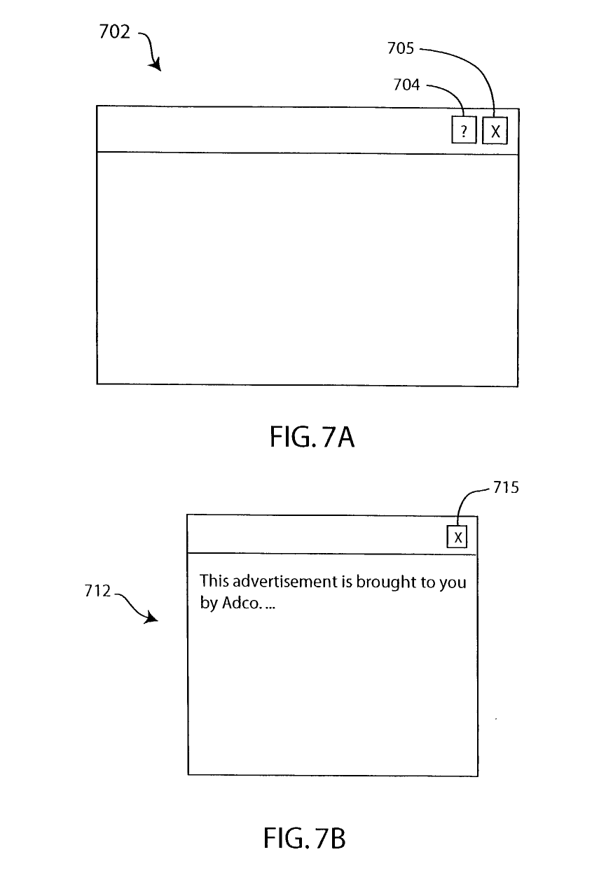

Another aspect of the present invention is now described with reference to FIGS. 7A and 7B. FIG. 7A shows a message delivery vehicle 702 in accordance with an embodiment of the present invention. Message delivery vehicle 702 may be a window, for example. Message delivery vehicle 702 may include an information icon 704 having a function similar to that of previously described information icon 504. For example, clicking on information icon 704 may bring-up a window 712 shown in FIG. 7B. That is, clicking on information icon 704 may bring up information regarding the source of a message contained in message delivery vehicle 702. Clicking on information icon 704 may also bring up other types of information or function.

As shown in FIG. 7A, message delivery vehicle 702 may also include a remove icon 705 for closing message delivery vehicle 702. For example, a consumer may click on remove icon 705 if she is not interested in the message contained in message delivery vehicle 702.

In the example of FIG. 7A, information icon 704 is placed adjacent to remove icon 705. One problem of placing information icon 704 and remove icon 705 in close proximity to each other is that a consumer may inadvertently click on information icon 704 when she actually intends to click on remove icon 705, or vice versa. In one embodiment of the present invention, the just described problem is alleviated by assigning different activation sequences to adjacent user interfaces such as information icon 704 and remove icon 705. For example, information icon 704 may require two clicks to activate it to bring up window 712, whereas remove button 715 may only require a single click to close message delivery vehicle 702. The two clicks to activate information icon 704 may be made one immediately after the other, be separated by any amount of time, be separated by a message or warning telling the consumer that icon 704 requires two clicks, or combinations thereof. As can be appreciated, assigning different activation sequences to user interfaces that are in close proximity to each other helps prevent inadvertent activation of a user interface.

The just described technique for preventing inadvertent activation of a user interface may be employed with user interfaces other than clickable icons. For example, the technique may also be used with adjacent hyperlinks, buttons, selections, etc. Additionally, activation of a user interface may be performed using a mouse button, a computer pointing device, or by other activation means without detracting from the merits of the present invention. The technique of assigning different activation sequences to adjacent user interfaces may be used in a variety of applications, and is specially useful in those applications where a particular user interface is more utilized than surrounding user interfaces.

While specific embodiments of the present invention have been provided, it is to be understood that these embodiments are for illustration purposes and not limiting. Many additional embodiments will be apparent to persons of ordinary skill in the art reading this disclosure. Thus, the present invention is limited only by the following claims.

What is claimed is:

1. A method of identifying a source of a message received over a computer network, the method comprising:
displaying a first message in a client computer, the first message including information educating a consumer about messages delivered by a source; and
displaying at least a second message in the client computer, the second message including a source indicator to dissociate the source of the first message and the second message from a publisher of a document displayed along with the second message in the client computer.

2. The method of claim 1 wherein the document includes a web page.

3. The method of claim 1 wherein the second message is displayed over the document.

4. The method of claim 1 wherein the second message is displayed in a window separate from the document.

5. The method of claim 1 wherein the second message is displayed in a pop-up window.

6. The method of claim 1 wherein the second message is displayed in a banner.

7. The method of claim 1 wherein the second message includes a logo.

8. The method of claim 1 wherein the first message includes textual information explicitly identifying the source of the first and second messages.

9. The method of claim 1 wherein the computer network includes the Internet.

10. The method of claim 1 wherein the second message includes an advertisement.

11. A series of windows displayed in a computer, the series comprising:
a first window including information regarding a first source;
a web page from a second source; and
a second window, the second window including a logo such that the second window is not associated with the second source when the second window is displayed along with the web page.

12. The series of claim 11 wherein the first window and the second window are transmitted to the computer over the Internet.

13. The series of claim 11 wherein the second window includes an advertisement.

14. The series of claim 11 wherein the second window includes a pop-up window.

15. The series of claim 11 wherein the second window includes a banner.

16. The series of claim 11 wherein the first window includes textual information regarding the first source.

17. A method of identifying a source of messages delivered over the Internet, the method comprising:
agreeing to a license agreement, the license agreement including a term allowing a source to deliver messages to a client computer;
receiving a first message from the source, the first message including textual information about message delivery by the source; and
receiving a second message from the source, the second message including a source indicator to dissociate the second message from a publisher of a web page being displayed along with the second message.

18. The method of claim 17 wherein the first message includes information regarding a term of the license agreement.

19. The method of claim 17 wherein the source indicator includes a logo.

20. The method of claim 17 wherein the second message includes an advertisement.

21. A method of activating a user interface in a computer system, the method comprising:
assigning a first activation sequence to a first user interface presented on a computer screen; and
assigning a second activation sequence to a second user interface that is in close proximity to the first user interface, the first activation sequence being different from the second activation sequence.

22. The method of claim 21 wherein the first activation sequence requires less clicks of a mouse button than the second activation sequence.

23. The method of claim 21 wherein the first user interface and the second user interface are side by side.

24. The method of claim 21 wherein the first user interface and the second user interface are icons on a first window displayed on a computer screen.

25. The method of claim 24 wherein activating the first user interface removes the first window from the computer screen.

26. The method of claim 24 wherein activating the second user interface brings up a second window containing information about a source of the first window.

27. A message delivery vehicle displayed on a computer screen, the message delivery vehicle comprising:
a first user interface that when activated removes a message from a computer screen;
a second user interface that when activated displays another message on the computer screen, the second user interface being displayed adjacent to the first user interface; and
wherein the first user interface and the second user interface are activated differently.

28. The message delivery vehicle of claim 27 wherein the first user interface and the second user interface are on a window displayed on the computer screen.

29. The message delivery vehicle of claim 27 wherein the first user interface is activated by clicking on the first user interface once with a mouse button and the second user interface is activated by clicking on the second user interface at least twice with a mouse button.

30. The message delivery vehicle of claim 27 wherein the first user interface and the second user interface are icons on a window displayed on the computer screen.

31. The message delivery vehicle of claim 27 wherein activating the second user interface displays a window containing a message about the source of a window displaying the second user interface and the first user interface.

32. A window displayed on a computer screen, the window comprising:
a source identifier identifying the source of the window;
a first icon that when activated removes the window from the computer screen;
a second icon that when activated displays another window on the computer screen, the second icon being displayed adjacent to the first icon; and
wherein the first icon and the second icon are activated differently.

33. The window of claim 32 wherein the first icon is activated with a single click of a mouse button and the second icon is activated with at least two clicks of a mouse button.

34. A window displayed on a computer screen, the window comprising:
a first icon that when activated removes the window from the computer screen; and
a second icon that provides an option to view a message regarding the source of the window.

35. The window of claim 34 wherein the second icon is displayed adjacent to the first icon, and wherein the first icon and the second icon are activated differently.

36. The window of claim 34 wherein the window contains advertising information.

37. The window of claim 34 wherein the window further comprises a source indicator.

38. A method of providing information regarding a source of a message, the method comprising:
receiving a message over a computer network;
displaying the message on a computer screen of a computer coupled to the computer network;
displaying a first icon on the computer screen; and
displaying information regarding a source of the message when at least the first icon is activated.

39. The method of claim 38 wherein the computer network includes the Internet.

40. The method of claim 38 further comprising displaying a second icon that when activated removes the message from the computer screen.

41. The method of claim 38 wherein the message includes advertising.
